(19) United States
(12) Patent Application Publication
(10) Pub. No.: US 2022/0254239 A1
(43) Pub. Date: Aug. 11, 2022

(54) Personal Tracking Assembly

(71) Applicant: Andre Brown, Houston, TX (US)

(72) Inventor: Andre Brown, Houston, TX (US)

(21) Appl. No.: 17/171,745

(22) Filed: Feb. 9, 2021

(51) Int. Cl. G08B 21/02; G08B 7/06

(52) U.S. Cl. CPC G08B 21/0288; G08B 21/0266; G08B 7/06; G08B 21/0205; G08B 21/0294

(57) ABSTRACT

A personal tracking assembly includes a base bracelet that is worn around a caregiver's wrist. A tracking unit is integrated into the base bracelet and the tracking unit is actuated to emit an audible alert and a haptic alert. A remote bracelet is worn around a wrist of a respective individual that is being supervised by the caregiver. A broadcasting unit is integrated into the remote bracelet and the broadcasting unit is in wireless communication with the tracking unit. The tracking unit emits the audible alert and the haptic alert when the tracking unit determines the broadcasting unit has moved beyond a predetermined distance from the tracking unit. In this way the broadcasting unit facilitates to the caregiver to be alerted that the respective individual is potentially in danger of becoming lost or kidnapped.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tracking devices and more particularly pertains to a new tracking device for facilitating a caregiver to track the location of multiple individuals. The tracking device is additionally in communication with a personal electronic device, such as a smart phone or the like to enhance the caretaker's ability to track the individuals.

### (2) Description of Related Art Including Information Disclosed Under 37 CFR 1.97 and 1.98

The prior art relates to tracking devices including a proximity alert that is wearable on a caregiver's shoe. The prior art discloses a variety of tracking devices that are worn on caregiver's wrists in the convention of a bracelet. Generally speaking, the signal strength between the tracking devices is monitored to generate an alarm when an individual moves too far from a caregiver. In no instance does the prior art disclose a plurality of tracking devices that are additionally in communication with a personal electronic device.

### BRIEF SUMMARY OF THE INVENTION

An embodiment of the disclosure meets the needs presented above by generally comprising a base bracelet that is worn around a caregiver's wrist. A tracking unit is integrated into the base bracelet and the tracking unit is actuated to emit an audible alert and a haptic alert. A remote bracelet is worn around a wrist of a respective individual that is being supervised by the caregiver. A broadcasting unit is integrated into the remote bracelet and the broadcasting unit is in wireless communication with the tracking unit. The tracking unit emits the audible alert and the haptic alert when the tracking unit determines the broadcasting unit has moved beyond a predetermined distance from the tracking unit. In this way the broadcasting unit facilitates to the caregiver to be alerted that the respective individual is potentially in danger of becoming lost or kidnapped.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a personal tracking assembly according to an embodiment of the disclosure.

FIG. 2 is a top phantom view of a remote bracelet and a broadcasting unit of an embodiment of the disclosure.

FIG. 3 is a top phantom view of base bracelet and a tracking unit of an embodiment of the disclosure.

FIG. 4 is a perspective in-use view of an embodiment of the disclosure.

FIG. 5 is a schematic view of an embodiment of the disclosure.

### DETAILED DESCRIPTION OF THE INVENTION

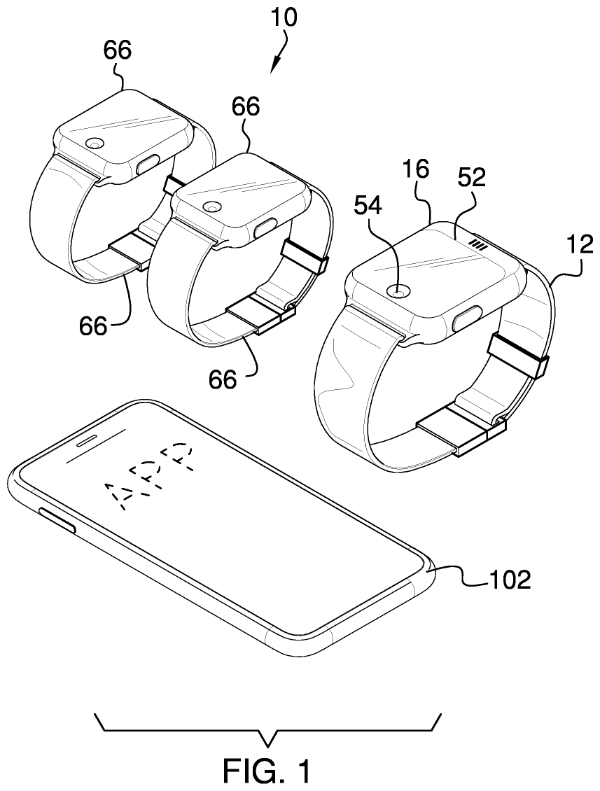

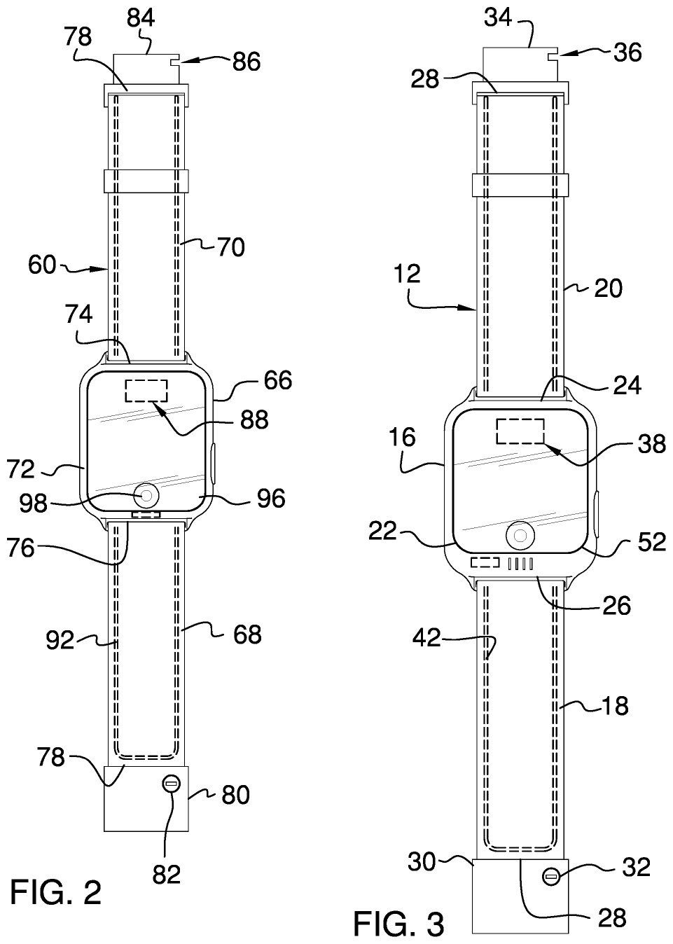

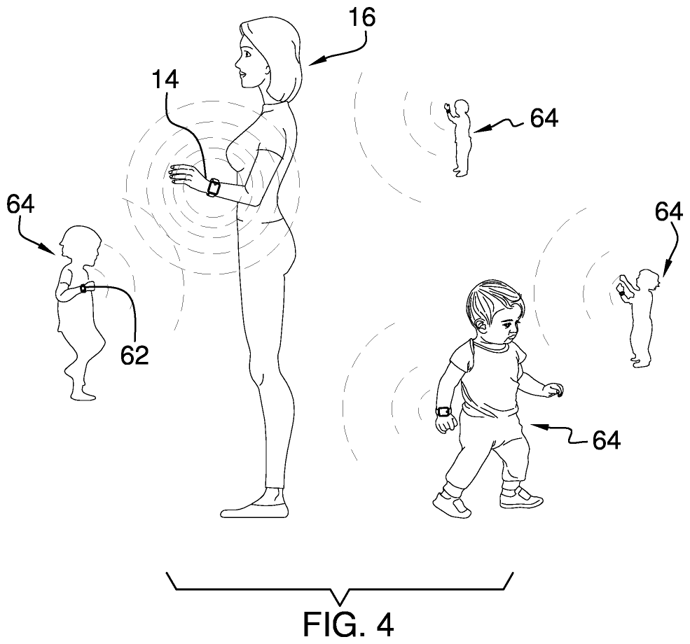

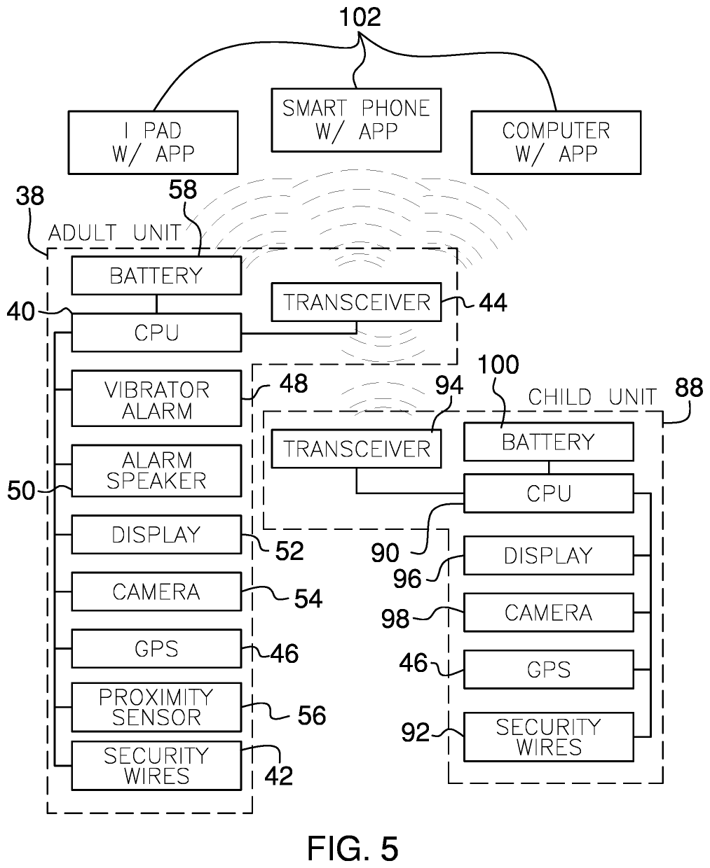

With reference now to the drawings, and in particular to FIGS. 1 through 5 thereof, a new tracking device embodying the principles and concepts of an embodiment of the disclosure and generally designated by the reference numeral 10 will be described.

As best illustrated in FIGS. 1 through 5, the personal tracking assembly 10 generally comprises a base bracelet 12 that can be worn around a wrist 14 of a caregiver 15. The base bracelet 12 includes a base housing 16, a first strap 18 that is coupled to the base housing 16 and a second strap 20 that is coupled to the base housing 16. The first strap 18 is matable to the second strap 20 such that the first strap 18 and the second strap 20 forms a closed loop that is retained on the caregiver's wrist 14. The base housing 16 has a top side 22, a first lateral side 24 and a second lateral side 26. The first strap 18 is coupled to and extends away from the first lateral side 24 and the second strap 20 is coupled to and extends away from the second lateral side 26. Each of the first strap 18 and the second strap 20 has a distal end 28 with respect to the base housing 16.

A receiver 30 is coupled to the distal end 28 of the first strap 18 and the receiver 30 has a lock 32 that is integrated therein. An insert 34 is coupled to the distal end 28 of the second strap 20 and the insert 34 has an engagement slot 36 extending therein. The insert 34 is insertable into the receiver 30 and the lock 32 releasably engages the engagement slot 36 for retaining the insert 34 in the receiver 30.

A tracking unit 38 is integrated into the base housing 16 and the tracking unit 38 is actuated to emit an audible alert. Additionally, the tracking unit 38 is actuated to emit a haptic alert. The tracking unit 38 comprises a base control circuit 40 that is integrated into the base housing 16. The base control circuit 40 receives an alert input and the base control circuit 40 receives a release input. A conductor 42 is integrated into each of the first strap 18 and the second strap 20 and the conductor 42 is electrically coupled to the base control circuit 40. The base control circuit 40 transmits a signal through the conductor 42. Moreover, the base control circuit 40 receives the release input when the signal is interrupted in the conductor 42. In this way the base control circuit 40 is alerted when either of the first strap 18 or the second strap 20 is forcibly removed from the caregiver's wrist 14.

The tracking unit 38 includes a base transceiver 44 that is integrated into the base housing 16 and the base transceiver 44 is electrically coupled to the base control circuit 40. The base transceiver 44 is in wireless communication with a global positioning system 46 to determine the physical location of the caregiver 15 when the caregiver 15 is wearing the tracking unit 38. The base transceiver 44 may comprise a radio frequency transceiver or the like.

The tracking unit 38 includes a vibration alert 48 that is integrated into the base housing 16 and the vibration alert 48 is electrically coupled to the base control circuit 40. The vibration alert 48 is turned on when the base control circuit 40 receives the alert input. Additionally, the vibration alert 48 vibrates the base housing 16 when the vibration alert 48 is turned on. In this way the vibration alert 48 can generate the haptic alert on the caregiver's wrist 14. The vibration alert 48 may comprise an electro-mechanical vibration unit that communicates an oscillating vibration into the base housing 16 when the vibration alert 48 is turned on.

The tracking unit 38 includes an audible alert 50 that is integrated into the base housing 16 and the audible alert 50 is electrically coupled to the base control circuit 40. The audible alert 50 is turned on when the base control circuit 40 receives the alert input. Additionally, the audible alert 50 emits an audible alarm when the audible alert 50 is turned on to audibly alert the caregiver 15. The audible alert 50 may comprise an electronic speaker or other type of device that can emit an audible alarm. The tracking unit 38 includes a display 52 that is coupled to the top side of the base housing 16 such that the display 52 is visible to the caregiver 15. The display 52 is electrically coupled to the base control circuit 40 and the display 52 displays indicia to communicate data to the caregiver 15. The display 50 may comprise an electronic touch screen such as an LED or the like.

The tracking unit 38 includes a camera 54 that is integrated into the base housing 16 to capture imagery of the environment surrounding the caregiver 15. The camera 54 is electrically coupled to the base control circuit 40 and the camera 54 may comprise a digital camera that can capture still imagery and video imagery. The tracking unit 38 includes a signal analyzer 56 that is integrated into the base housing 16 and the signal analyzer 56 is electrically coupled to the base control circuit 40. The signal analyzer 56 analyzes the signal strength of a signal received by the base transceiver 44. Moreover, the base control circuit 40 receives the alert input when the signal analyzer 56 determines the signal received by the base transceiver 44 falls below a predetermined signal threshold. The tracking unit 38 includes a base power supply 58 that is integrated into the base housing 16, the base power supply 58 is electrically coupled to the base control circuit 40 and the base power supply 58 comprises at least one battery.

A remote bracelet 60 is provided that can be worn around a wrist 62 of a respective individual 64 that is being supervised by the caregiver 15. The remote bracelet 60 includes a remote housing 66, a primary strap 68 that is coupled to the remote housing 66 and a secondary strap 70 that is coupled to the remote housing 66. The primary strap 68 is matable to the secondary strap 70 such that the primary strap 68 and the secondary strap 70 forms a closed loop. In this way the remote housing 66 can be retained on the respective individual's wrist 62.

The remote housing 66 has a top side 72, a first lateral side 74 and a second lateral side 76, and the primary strap 68 is coupled to and extends away from the first lateral side 74 of the remote housing 66. The secondary strap 70 is coupled to and extends away from the second lateral side 76 of the remote housing 66. Additionally, each of the primary strap 68 and the secondary strap 70 has a distal end 78 with respect to the remote housing 66. A receiver 80 is coupled to the distal end 78 of the primary strap 68 and the receiver 80 on the primary strap 68 has a lock 82 that is integrated therein. An insert 84 is coupled to the distal end 78 of the secondary strap 70 and the insert 84 on the secondary strap 70 has an engagement slot 86 extending therein. The insert 84 on the secondary strap 70 is insertable into the receiver 80 on the primary strap 68. Moreover, the lock 82 in the receiver 80 on the primary strap 68 releasably engages the engagement slot 86 in the insert 84 on the secondary strap 70 for retaining the insert 84 on the secondary strap 70 in the receiver 80 on the first strap 18.

A broadcasting unit 88 is integrated into the remote housing 66 and the broadcasting unit 88 is actuated to emit an audible alert 50 and a haptic alert. The broadcasting unit 88 is in wireless communication with the tracking unit 38 and the tracking unit 38 emits the audible alert 50 and the haptic alert when the tracking unit 38 determines the broadcasting unit 88 has moved beyond a predetermined distance from the tracking unit 38. In this way the broadcasting unit 88 can facilitate to the caregiver 15 to be alerted that the respective individual 64 is potentially in danger of becoming lost or kidnapped.

The broadcasting unit 88 comprises a remote control circuit 90 that is integrated into the remote housing 66, and the remote control circuit 90 receives a release input. A conductor 92 is integrated into each of the primary strap 68 and the secondary strap 70, and the conductor 92 is electrically coupled to the remote control circuit 90. The remote control circuit 90 transmits a signal through the conductor 92 and the remote control circuit 90 receives the release input when the signal is interrupted in the conductor 92. In this way the remote control circuit 90 is alerted when either of the primary strap 68 or the secondary strap 70 is forcibly removed from the respective individual's wrist 62.

The broadcasting unit 88 includes a remote transceiver 94 that is integrated into the remote housing 66 and the remote transceiver 94 is electrically coupled to the remote control circuit 90. The remote transceiver 94 is in wireless communication with a global positioning system 46 to determine the physical location of the respective individual 64 when the respective individual 64 is wearing the broadcasting unit 88. The remote transceiver 94 is in wireless communication with the base transceiver 44 and the remote transceiver 94 broadcasts a release signal to the base transceiver 44 when the remote control circuit 90 receives the release input. Moreover, the base control circuit 40 receives the release input when the base transceiver 44 receives the release signal to alert the caregiver 15 that the broadcasting unit 88 has been forcibly removed from the respective individual 64's wrist. The remote transceiver 94 may comprise a radio frequency transceiver or the like.

A display 96 is coupled to the top side 72 of the remote housing 66 such that the display 96 on the remote housing 66 is visible to the respective individual 64. The display 96 on the remote housing 66 is electrically coupled to the remote control circuit 90 and the display 96 on the remote housing 66 displays indicia to communicate data to the respective individual 64. The display 96 on the remote housing 66 may comprise an electronic touch screen display or the like. A camera 98 is integrated into the remote housing 66 to capture imagery of the environment surrounding the respective individual 64 and the camera 98 on the remote housing 66 is electrically coupled to the remote control circuit 90. The camera 98 on the remote housing 66 may comprise a digital camera that is capable of capturing video imagery and still imagery. A remote power supply 100 is integrated into the remote housing 66, the remote power supply 100 is electrically coupled to the remote control circuit 90 and the remote power supply 100 comprising at least one battery.

A personal electronic device 102 is provided and the personal electronic device 102 may be carried by the caregiver 16. The personal electronic device 102 is in wireless communication with the base tracking unit 38. Additionally, the personal electronic device 102 displays indicia relating to the location of the broadcasting unit 88 with respect to the tracking unit 38. In this way wherein the personal electronic device 102 can facilitate the caregiver 15 to visually identify the location of each individual 64. The personal electronic device 102 may comprise a smart phone, a personal computer or other type of personal electronic device that has wireless communication capabilities. Additionally, the personal electronic device 102 might store tracking software, such as a smart phone app or the like, to facilitate enhanced tracking ability for the caregiver 16.

In use, the base bracelet 12 is worn on the caregiver's wrist 14 and up to thirty two of the remote bracelets 60 can be worn on as many of the individuals 64. In this way the caregiver 15 can track the location of each of the individuals 64 in a public location, such as an amusement park, a beach or any other open location. The display on the base housing 16 can be manipulated to program a desired threshold distance into the base control circuit 40, which may be a distance of up to 1500.0 feet. In this way the caregiver 15 can be notified when any of the individuals 64 moves beyond the threshold distance from the caregiver 15. Additionally, the display 52 on the base housing 16 can display the physical location of each individual 64 in a similar fashion to existing gps software. Thus, the caregiver 15 can continually monitor the location of each individual 64. In this way the caregiver 15 can keep constant track of the individuals 64 that the caregiver 15 has been tasked with supervising.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A personal tracking assembly to facilitate a caregiver track the location one or more individuals, said assembly comprising:
a base bracelet being configured to be worn around a caregiver's wrist, said base bracelet including a base housing, a first strap being coupled to said base housing and a second strap being coupled to said base housing, said first strap and said second strap extending from said base housing in opposite directions, said first strap being matable to said second strap such that said first strap and said second strap forms a closed loop wherein said base housing is configured to be retained on the caregiver's wrist;
a tracking unit being integrated into said base housing, said tracking unit being actuated to emit an audible alert, said tracking unit being actuated to emit a haptic alert;
a remote bracelet being configured to be worn around a wrist of a respective individual that is being supervised by the caregiver, said remote bracelet including a remote housing, a primary strap being coupled to said remote housing and a secondary strap being coupled to said remote housing, said primary strap being ratable to said secondary strap such that said primary strap and said secondary strap forms a closed loop wherein said remote housing is configured to be retained on the respective individual's wrist;
a broadcasting unit being integrated into said remote housing, said broadcasting unit being actuated to emit an audible alert, said broadcasting unit being actuated to emit a haptic alert, said broadcasting unit being in wireless communication with said tracking unit, said tracking unit emitting said audible alert and said haptic alert when said tracking unit determines said broadcasting unit has moved beyond a predetermined distance from said tracking unit wherein said broadcasting unit is configured to facilitate to the caregiver to be alerted that the respective individual is potentially in danger of becoming lost or kidnapped;
a personal electronic device being configured to be carried by the caregiver, said personal electronic device being in wireless communication with said tracking unit, said personal electronic device displaying indicia relating to the location of each broadcasting unit with respect to said tracking unit wherein said personal electronic device is configured to facilitate the caregiver to visually identify the location of each individual;
wherein said tracking unit comprises a base control circuit being integrated into said base housing, said base control circuit receiving an alert input, said base control unit receiving a release input; and
wherein said tracking unit includes a conductor being integrated into each of said first strap and said second strap, said conductor extending in a U-shape along a periphery of said first strap, said conductor extending along said second strap adjacent to opposed longitudinal edges of said second strap, said conductor being electrically coupled to said base control circuit, said base control circuit transmitting a signal through said conductor, said base control circuit receiving said release input when said signal is interrupted in said conductor wherein said base control circuit is configured to be alerted when either of said first strap or said second strap is forcibly removed from the caregivers wrist.

2. The assembly according to claim 1, further comprising:
said base housing having a top side, a first lateral side and a second lateral side, said first strap being coupled to and extending away from said first lateral side, said second strap being coupled to and extending away from said second lateral side, each of said first strap and said second strap having a distal end with respect to said base housing;
a receiver being coupled to said distal end of said first strap, said receiver having a lock being integrated therein; and
an insert being coupled to said distal end of said second strap, said insert having an engagement slot extending therein, said insert being insertable into said receiver, said lock releasably engaging said engagement slot for retaining said insert in said receiver.

3. (canceled)

4. (canceled)

5. The assembly according to claim 1, wherein said tracking unit includes a base transceiver being integrated into said base housing, said base transceiver being electrically coupled to said base control circuit, said base transceiver being in wireless communication with a global positioning system wherein said base transceiver is configured to determine the physical location of the caregiver when the caregiver is wearing said tracking unit.

6. The assembly according to claim 1, wherein:
said tracking unit includes a vibration alert being integrated into said base housing, said vibration alert being electrically coupled to said base control circuit, said vibration alert being turned on when said base control circuit receives said alert input, said vibration alert vibrating said base housing when said vibration alert is turned on wherein said vibration alert is configured to generate said haptic alert on the caregiver's wrist; and
said tracking unit includes an audible alert being integrated into said housing, said audible alert being electrically coupled to said base control circuit, said audible alert being turned on when said base control circuit receives said alert input, said audible alert emitting an audible alarm when said audible alert is turned on wherein said audible alert is configured to audibly alert the caregiver.

7. The assembly according to claim 1, wherein said tracking unit includes a display being coupled to said top side of said base housing wherein said display is configured to be visible to the caregiver, said display being electrically coupled to said base control circuit, said display displaying indicia wherein said display is configured to communicate data to the caregiver.

8. The assembly according to claim 1, wherein said tracking unit includes a camera being integrated into said base housing wherein said camera is configured to capture imagery of the environment surrounding the caregiver, said camera being electrically coupled to said base control circuit.

9. The assembly according to claim 5, wherein said tracking unit includes a signal analyzer being integrated into said base housing, said signal analyzer being electrically coupled to said base control circuit, said signal analyzer analyzing a signal strength of a signal received by said base transceiver, said control circuit receiving said alert input when said signal analyzer determines the signal received by said base transceiver falls below a predetermined signal threshold.

10. The assembly according to claim 1, further comprising:
said remote housing having a top side, a first lateral side and a second lateral side, said primary strap being coupled to and extending away from said first lateral side of said remote housing, said secondary strap being coupled to and extending away from said second lateral side of said remote housing, each of said primary strap and said secondary strap having a distal end with respect to said remote housing;
a receiver being coupled to said distal end of said primary strap, said receiver having a lock being integrated therein; and
an insert being coupled to said distal end of said secondary strap, said insert on said secondary strap having an engagement slot extending therein, said insert on said secondary strap being insertable into said receiver on said primary strap, said lock in said receiver on said primary strap releasably engaging said engagement slot in said insert on said secondary strap for retaining said insert on said secondary strap in said receiver on said first strap.

11. The assembly according to claim 10, wherein said broadcasting unit comprises a remote control circuit being integrated into said remote housing, said remote control circuit receiving a release input.

12. (canceled)

13. The assembly according to claim 11, wherein said broadcasting unit includes a remote transceiver being integrated into said remote housing, said remote transceiver being electrically coupled to said remote control circuit, said remote transceiver being in wireless communication with a global positioning system wherein said remote transceiver is configured to determine the physical location of the respective individual when the respective individual is wearing said broadcasting unit.

14. The assembly according to claim 13, wherein:
said tracking unit comprises a base control circuit being integrated into a base housing, said base control circuit receiving an alert input;
said tracking unit includes a base transceiver being integrated into said base housing, said base transceiver being electrically coupled to said base control circuit; and
said remote transceiver is in wireless communication with said base transceiver, said remote transceiver broadcasting a release signal to said base transceiver when said remote control circuit receives said release input, said base control circuit receiving said release input when said base transceiver receives said release signal wherein said base control circuit is configured to alert the caregiver that the broadcasting unit has been forcibly removed from the respective individual's wrist.

15. The assembly according to claim 11, wherein said broadcasting unit includes a display being coupled to said top side of said remote housing wherein said display is configured to be visible to the respective individual, said display being electrically coupled to said control circuit, said display displaying indicia wherein said display is configured to communicate data to the respective individual.

16. The assembly according to claim 11, further comprising a camera being integrated into said remote housing wherein said camera is configured to capture imagery of the environment surrounding the respective individual, said camera being electrically coupled to said remote control circuit.

17. A personal tracking assembly to facilitate a caregiver to track the location one or more individuals, said assembly comprising:
a base bracelet being configured to be worn around a caregiver's wrist, said base bracelet including a base housing, a first strap being coupled to said base housing and a second strap being coupled to said base housing, said first strap and said second strap extending from said base housing in opposite directions, said first strap being ratable to said second strap such that said first strap and said second strap forms a closed loop wherein said base housing is configured to be retained on the caregiver's wrist, said base housing having a top side, a first lateral side and a second lateral side, said first strap being coupled to and extending away from said first lateral side, said second strap being coupled to and extending away from said second lateral side, each of said first strap and said second strap having a distal end with respect to said base housing;
a receiver being coupled to said distal end of said first strap, said receiver having a lock being integrated therein;
an insert being coupled to said distal end of said second strap, said insert having an engagement slot extending therein, said insert being insertable into said receiver, said lock releasably engaging said engagement slot for retaining said insert in said receiver;
a tracking unit being integrated into said base housing, said tracking unit being actuated to emit an audible alert, said tracking unit being actuated to emit a haptic alert, said tracking unit comprising:
a base control circuit being integrated into said base housing, said base control circuit receiving an alert input, said base control unit receiving a release input;
a conductor being integrated into each of said first strap and said second strap, said conductor extending in a U-shape along a periphery of said first strap, said conductor extending along said second strap adjacent to opposed longitudinal edges of said second strap, said conductor being electrically coupled to said base control circuit, said base control circuit transmitting a signal through said conductor, said base control circuit receiving said release input when said signal is interrupted in said conductor wherein said base control circuit is configured to be alerted when either of said first strap or said second strap is forcibly removed from the caregivers wrist;
a base transceiver being integrated into said base housing, said base transceiver being electrically coupled to said base control circuit, said base transceiver being in wireless communication with a global positioning system wherein said base transceiver is configured to determine the physical location of the caregiver when the caregiver is wearing said tracking unit;
a vibration alert being integrated into said base housing, said vibration alert being electrically coupled to said base control circuit, said vibration alert being turned on when said base control circuit receives said alert input, said vibration alert vibrating said base housing when said vibration alert is turned on wherein said vibration alert is configured to generate said haptic alert on the caregiver's wrist;
an audible alert being integrated into said housing, said audible alert being electrically coupled to said base control circuit, said audible alert being turned on when said base control circuit receives said alert input, said audible alert emitting an audible alarm when said audible alert is turned on wherein said audible alert is configured to audibly alert the caregiver;
a display being coupled to said top side of said base housing wherein said display is configured to be visible to the caregiver, said display being electrically coupled to said base control circuit, said display displaying indicia wherein said display is configured to communicate data to the caregiver;
a camera being integrated into said base housing wherein said camera is configured to capture imagery of the environment surrounding the caregiver, said camera being electrically coupled to said base control circuit;
a signal analyzer being integrated into said base housing, said signal analyzer being electrically coupled to said base control circuit, said signal analyzer analyzing a signal strength of a signal received by said base transceiver, said control circuit receiving said alert input when said signal analyzer determines the signal received by said base transceiver falls below a predetermined signal threshold; and
a base power supply being integrated into said base housing, said base power supply being electrically coupled to said base control circuit, said base power supply comprising at least one battery; and
a remote bracelet being configured to be worn around a wrist of a respective individual that is being supervised by the caregiver, said remote bracelet including a remote housing, a primary strap being coupled to said remote housing and a secondary strap being coupled to said remote housing, said primary strap being matable to said secondary strap such that said primary strap and said secondary strap forms a closed loop wherein said remote housing is configured to be retained on the respective individual's wrist, said remote housing having a top side, a first lateral side and a second lateral side, said primary strap being coupled to and extending away from said first lateral side of said remote housing, said secondary strap being coupled to and extending away from said second lateral side of said remote housing, each of said primary strap and said secondary strap having a distal end with respect to said remote housing;
a receiver being coupled to said distal end of said primary strap, said receiver having a lock being integrated therein;
an insert being coupled to said distal end of said secondary strap, said insert on said secondary strap having an engagement slot extending therein, said insert on said secondary strap being insertable into said receiver on said primary strap, said lock in said receiver on said primary strap releasably engaging said engagement slot in said insert on said secondary strap for retaining said insert on said secondary strap in said receiver on said first strap;
a broadcasting unit being integrated into said remote housing, said broadcasting unit being actuated to emit an audible alert, said broadcasting unit being actuated to emit a haptic alert, said broadcasting unit being in wireless communication with said tracking unit, said tracking unit emitting said audible alert and said haptic alert when said tracking unit determines said broadcasting unit has moved beyond a predetermined distance from said tracking unit wherein said broadcasting unit is configured to facilitate to the caregiver to be alerted that the respective individual is potentially in danger of becoming lost or kidnapped, said broadcasting unit comprising:
a remote control circuit being integrated into said remote housing, said remote control circuit receiving a release input;
a conductor being integrated into each of said primary strap and said secondary strap, said conductor being electrically coupled to said remote control circuit, said remote control circuit transmitting a signal through said conductor, said remote control circuit receiving said release input when said signal is interrupted in said conductor wherein said remote control circuit is configured to be alerted when either of said primary strap or said secondary strap is forcibly removed from the respective individual's wrist;
a remote transceiver being integrated into said remote housing, said remote transceiver being electrically coupled to said remote control circuit, said remote transceiver being in wireless communication with a global positioning system wherein said remote transceiver is configured to determine the physical location of the respective individual when the respective individual is wearing said broadcasting unit, said remote transceiver being in wireless communication with said base transceiver, said remote transceiver broadcasting a release signal to said base transceiver when said remote control circuit receives said release input, said base control circuit receiving said release input when said base transceiver receives said release signal wherein said base control circuit is configured to alert the caregiver that the broadcasting unit has been forcibly removed from the respective individual's wrist;
a display being coupled to said top side of said remote housing wherein said display is configured to be visible to the respective individual, said display being electrically coupled to said control circuit, said display displaying indicia wherein said display is configured to communicate data to the respective individual;
a camera being integrated into said remote housing wherein said camera is configured to capture imagery of the environment surrounding the respective individual, said camera being electrically coupled to said remote control circuit; and
a remote power supply being integrated into said remote housing, said remote power supply being electrically coupled to said remote control circuit, said remote power supply comprising at least one battery; and
a personal electronic device being configured to be carried by the caregiver, said personal electronic device being in wireless communication with said tracking unit, said personal electronic device displaying indicia relating to the location of each broadcasting unit with respect to said tracking unit wherein said personal electronic device is configured to facilitate the caregiver to visually identify the location of each individual.
